(19) United States
(12) Patent Application Publication
(10) Pub. No.: US 2024/0289872 A1
(43) Pub. Date: Aug. 29, 2024

(54) INTELLIGENT SHORT-TERM RENTAL/LENDING COORDINATION

(71) Applicant: STATE FARM MUTUAL AUTOMOBILE INSURANCE COMPANY, Bloomington, IL (US)

(72) Inventors: Brian Mark Fields, Phoenix, AZ (US); Nathan L. Tofte, Downs, IL (US); Joseph Robert Brannan, Bloomington, IL (US); Vicki King, Bloomington, IL (US); Justin Davis, Bloomington, IL (US)

(21) Appl. No.: 18/378,512

(22) Filed: Oct. 10, 2023

Related U.S. Application Data
(60) Provisional application No. 63/465,736, filed on May 11, 2023.
(60) Provisional application No. 63/463,376, filed on May 2, 2023.
(60) Provisional application No. 63/487,149, filed on Feb. 27, 2023.

(51) Int. Cl. G06Q 30/0645; G06Q 30/0202; G06Q 30/08; G06Q 40/08

(52) U.S. Cl. CPC G06Q 30/0645; G06Q 30/0202; G06Q 30/08; G06Q 40/08

(57) ABSTRACT

Techniques for intelligent coordination between parties for short-term rental or lending of items are disclosed herein. An exemplary computer-implemented method includes aggregating party data from the plurality of parties, and determining, by executing a machine learning (ML) chatbot, one or more items associated with each party of the plurality of parties. The ML chatbot is trained using a plurality of training party data from a plurality of training parties as input to output a plurality of training items associated with the plurality of training parties. The computer-implemented method may further include generating, by executing the ML chatbot, a set of associated parties that includes at least a pair of parties from the plurality of parties for each item of the one or more items; and for each set of parties, initiating contact between parties.

### CROSS-REFERENCE TO RELATED APPLICATIONS

This application claims priority to and the benefit of the filing date of U.S. Provisional Patent Application No. 63/465,736 entitled “INTELLIGENT SHORT-TERM RENTAL/LENDING COORDINATION,” filed on May 11, 2023, U.S. Provisional Patent Application No. 63/463,376 entitled “INTELLIGENT SHORT-TERM RENTAL/LENDING COORDINATION,” filed on May 2, 2023, and U.S. Provisional Patent Application No. 63/487,149 entitled “Systems and Methods for Intelligent Short-Term Rental/Lending Coordination,” filed on Feb. 27, 2023, the entire contents of each of which are hereby expressly incorporated herein by reference.

### FIELD OF THE INVENTION

The present disclosure generally relates to coordination between parties for short-term or lending of items, and more particularly, intelligent coordination between parties for short-term rental or lending of items via a machine learning (ML) chatbot and/or artificial intelligence (AI) (or voice bot).

### BACKGROUND

Generally speaking, short-term rental or lending may include an exchange of item(s) between two or more parties for terms agreed upon by the parties. In conventional short-term rental or lending, a first party may post to various forums, including a community group, social media platform, or other in-person or electronic platform to indicate an item in the party's possession that is available for lending or rental. A second party may then contact the first party indicating interest in the item, and the two parties may agree to exchange terms for a short-term rental or lending of the item. Likewise, a second party may post their need/desire for an item to an aforementioned forum in search of a first party offering the needed item.

These conventional techniques may rely on, for example: (i) the first party knowing what items are in their possession, (ii) the first party knowing and/or anticipating demand for the item exists, (iii) the first party posting the item for rental/lending to a platform (e.g., community group, social media platform) viewed by the second party (and vice versa), and (iv) the first and second party having complementary exchange terms for the item. Accordingly, conventional techniques may frequently depend on circumstance and/or coincidence, in addition to the complications posed by either party attempting to coordinate the item exchange.

Conventional techniques may include additional drawbacks, inefficiencies, encumbrances, and/or ineffectiveness. For example, parties may be limited by a number of short-term rentals or lending a party is able to coordinate at one time. Additionally, parties may often be limited to contacting parties who may or may not own/be looking for the item, and who may or may not have complementary exchange terms. This may result in the high likelihood of two incompatible parties initiating coordination and the exchange never being completed. Accordingly, conventional techniques may be generally inefficient, have limited reach, and require significant effort on behalf of any participating party.

### SUMMARY

The present embodiments may relate to, inter alia, systems and methods for intelligent coordination for short-term rental or lending of items via a ML and/or an AI chatbot (or voice bot).

In one aspect, a computer system for intelligent short-term rental or lending coordination by a ML chatbot for a plurality of parties. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice or chat bots, ChatGPT bots, and/or other electronic or electrical components, which may be in wired or wireless communication with one another. In one instance, the computer system may comprise one or more processors and a memory storing executable instructions thereon that, when executed by the one or more processors, cause the one or more processors to: (1) aggregate party data from the plurality of parties, (2) determine, by executing a ML chatbot, one or more items associated with each party of the plurality of parties, wherein the ML chatbot is trained using a plurality of training party data from a plurality of training parties as input to output a plurality of training items associated with the plurality of training parties, (3) generate, by executing the ML chatbot, a set of associated parties that includes at least a pair of parties from the plurality of parties for each item of the one or more items, and/or (4) for each set of parties, initiate contact between parties (such as between (i) parties, (ii) party computing devices; and/or (iii) party voice or chat bots). The computer system may include additional, less, or alternate functionality, including that discussed elsewhere herein.

In another aspect, a computer-implemented method for intelligent short-term rental or lending coordination by a ML chatbot for a plurality of parties. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice or chat bots, ChatGPT bots, and/or other electronic or electrical components, which may be in wired or wireless communication with one another. In one instance, the computer-implemented method may include: (1) aggregating party data from the plurality of parties, (2) determining, by executing a ML chatbot, one or more items associated with each party of the plurality of parties, wherein the ML chatbot is trained using a plurality of training party data from a plurality of training parties as input to output a plurality of training items associated with the plurality of training parties, (3) generating, by executing the ML chatbot, a set of associated parties that includes at least a pair of parties from the plurality of parties for each item of the one or more items, and/or (4) for each set of parties, initiating contact between parties (such as between (i) parties, (ii) party computing devices; and/or (iii) party voice or chat bots). The method may include additional, less, or alternate functionality or actions, including those discussed elsewhere herein.

In another aspect, a non-transitory computer-readable medium storing non-transitory computer readable instructions stored thereon for intelligent short-term rental or lending coordination by a ML chatbot for a plurality of parties. The instructions, when executed on one or more processors, may cause the one or more processors to: (1) aggregate party data from the plurality of parties, (2) determine, by executing a ML chatbot, one or more items associated with each party of the plurality of parties, wherein the ML chatbot is trained using a plurality of training party data from a plurality of training parties as input to output a plurality of training items associated with the plurality of training parties, (3) generate, by executing the ML chatbot, a set of associated parties that includes at least a pair of parties from the plurality of parties for each item of the one or more items, and/or (4) for each set of parties, initiate contact between parties (such as between (i) parties, (ii) party computing devices; and/or (iii) party voice or chat bots). The instructions may direct additional, less, or alternate functionality, including that discussed elsewhere herein.

In another aspect, a computer system for intelligent short-term rental or lending coordination by an AI chatbot for a plurality of parties. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice or chat bots, ChatGPT bots, and/or other electronic or electrical components, which may be in wired or wireless communication with one another. In one instance, the computer system may comprise one or more processors and a memory storing executable instructions thereon that, when executed by the one or more processors, cause the one or more processors to: (1) aggregate party data from the plurality of parties, (2) determine, by executing an AI chatbot, one or more items associated with each party of the plurality of parties, wherein the AI chatbot is trained using a plurality of training party data from a plurality of training parties as input to output a plurality of training items associated with the plurality of training parties, (3) generate, by executing the AI chatbot, a set of associated parties that includes at least a pair of parties from the plurality of parties for each item of the one or more items, and/or (4) for each set of parties, initiate contact between parties. The computer system may include additional, less, or alternate functionality, including that discussed elsewhere herein.

In another aspect, a computer system for intelligent short-term rental or lending coordination by an AI chatbot for a plurality of parties. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice or chat bots, ChatGPT bots, and/or other electronic or electrical components, which may be in wired or wireless communication with one another. In one instance, the computer system may comprise one or more processors and a memory storing executable instructions thereon that, when executed by the one or more processors, cause the one or more processors to: (1) aggregate party data from a plurality of electronic devices respectively associated with the plurality of parties, (2) determine, by executing an AI chatbot, one or more items associated with each party of the plurality of parties, wherein the AI chatbot is trained using a plurality of training party data from a plurality of training parties as input to output a plurality of training items associated with the plurality of training parties, (3) generate, by executing the AI chatbot, a set of associated parties that includes at least a pair of parties from the plurality of parties for each item of the one or more items, and/or (4) for each set of parties, initiate contact between an electronic device associated with each party. The computer system may include additional, less, or alternate functionality, including that discussed elsewhere herein.

In another aspect, a computer system intelligent short-term rental or lending coordination by a ML or an AI chatbot for a plurality of parties. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice or chat bots, ChatGPT bots, and/or other electronic or electrical components, which may be in wired or wireless communication with one another. In one instance, the computer system may comprise one or more processors and a memory storing executable instructions thereon that, when executed by the one or more processors, cause the one or more processors to: (1) aggregate party data from a plurality of electronic devices (such as a mobile device, computing device, wearable, virtual reality headset, augmented reality glasses, voice or chat bot, or AI or ML chatbot) respectively associated with the plurality of parties, (2) determine, by executing an AI chatbot, one or more items associated with each party of the plurality of parties, wherein the AI chatbot is trained using a plurality of training party data from a plurality of training parties as input to output a plurality of training items associated with the plurality of training parties, (3) generate, by executing the AI chatbot, a set of associated parties that includes at least a pair of parties from the plurality of parties for each item of the one or more items, and/or (4) for each set of parties, initiate contact between an electronic device (such as a mobile device, computing device, wearable, virtual reality headset, augmented reality glasses, voice or chat bot, or AI or ML chatbot) associated with each party. The computer system may include additional, less, or alternate functionality, including that discussed elsewhere herein.

In another aspect, a computer system for intelligent short-term rental or lending coordination by a ML chatbot for a plurality of parties. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice or chat bots, ChatGPT bots, and/or other electronic or electrical components, which may be in wired or wireless communication with one another. In one instance, the computer system may comprise one or more processors and a memory storing executable instructions thereon that, when executed by the one or more processors, cause the one or more processors to: (1) aggregate party data from a plurality of electronic devices respectively associated with the plurality of parties, (2) determine, by executing a ML chatbot, one or more items associated with each party of the plurality of parties, wherein the ML chatbot is trained using a plurality of training party data from a plurality of training parties as input to output a plurality of training items associated with the plurality of training parties, (3) generate, by executing the ML chatbot, a set of associated parties that includes at least a pair of parties from the plurality of parties for each item of the one or more items, and/or (4) for each set of parties, initiate contact between an electronic device associated with each party. The computer system may include additional, less, or alternate functionality, including that discussed elsewhere herein.

In another aspect, a computer system for intelligent short-term rental or lending coordination by a ML or AI chatbot for a plurality of parties. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice or chat bots, ChatGPT bots, and/or other electronic or electrical components, which may be in wired or wireless communication with one another. In one instance, the computer system may comprise one or more processors and a memory storing executable instructions thereon that, when executed by the one or more processors, cause the one or more processors to: (1) aggregate party data from a plurality of electronic devices (such as a mobile device, computing device, wearable, virtual reality headset, augmented reality glasses, voice or chat bot, or AI or ML chatbot) respectively associated with the plurality of parties, (2) determine, by executing an ML chatbot, one or more items associated with each party of the plurality of parties, wherein the ML chatbot is trained using a plurality of training party data from a plurality of training parties as input to output a plurality of training items associated with the plurality of training parties, (3) generate, by executing the ML chatbot, a set of associated parties that includes at least a pair of parties from the plurality of parties for each item of the one or more items, and/or (4) for each set of parties, initiate contact between an electronic device (such as a mobile device, computing device, wearable, virtual reality headset, augmented reality glasses, voice or chat bot, or AI or ML chatbot) associated with each party. The computer system may include additional, less, or alternate functionality, including that discussed elsewhere herein.

Additional, alternate and/or fewer actions, steps, features and/or functionality may be included in an aspect and/or embodiments, including those described elsewhere herein.

In accordance with the above, and with the disclosure herein, the present disclosure includes improvements in computer functionality or in improvements to other technologies at least because the disclosure describes that, e.g., a hosting server (e.g., central server), or otherwise computing device (e.g., a user computing device), is improved where the intelligence or predictive ability of the hosting server or computing device is enhanced by a trained machine learning chatbot/voice bot. This model, executing on the hosting server or user computing device, is able to accurately and efficiently coordinate short-term rental/lending between parties. That is, the present disclosure describes improvements in the functioning of the computer itself or “any other technology or technical field” because a hosting server or user computing device, is enhanced with a trained machine learning chatbot/voice bot to accurately determine one or more items associated with a party based upon party data and generate a set of associated parties for each item of the one or more items to initiate contact between respective parties for short-term rental/lending of items. This improves over the prior art at least because existing systems lack such diagnostic and/or predictive functionality, and are generally unable to accurately determine items owned and/or desired by a party, generate sets of compatible parties, and/or otherwise successfully coordinate short-term rental/lending of items.

As mentioned, the model(s) may be trained using machine learning and may utilize machine learning during operation. Therefore, in these instances, the techniques of the present disclosure may further include improvements in computer functionality or in improvements to other technologies at least because the disclosure describes such models being trained with a plurality of training data (e.g., training party data, training parties, training items training exchange terms, training commonality values, etc.) to output the coordination system-specific conditions configured to coordinate short-term rental/lending among/between parties.

Moreover, the present disclosure includes effecting a transformation or reduction of a particular article to a different state or thing, e.g., transforming or reducing the coordination of short-term rental/lending of items among/between parties from a non-optimal or error state to an optimal state.

Still further, the present disclosure includes specific features other than what is well-understood, routine, conventional activity in the field, or adding unconventional steps that demonstrate, in various embodiments, particular useful applications, e.g., determining, by one or more processors executing a machine learning (ML) chatbot, one or more items associated with each party of a plurality of parties, wherein the ML chatbot is trained using a plurality of training party data from a plurality of training parties as input to output a plurality of training items associated with the plurality of training parties; and/or generating, by executing an ML chatbot, a set of associated parties that includes at least a pair of parties from the plurality of parties for each item of the one or more items.

### BRIEF DESCRIPTION OF THE DRAWINGS

The figures described below depict various aspects of the applications, methods, and systems disclosed herein. It should be understood that each figure depicts one embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts a block diagram of an exemplary computer system in which methods and systems for intelligent short-term rental or lending coordination for a plurality of parties via an AI and/or ML chatbot may be implemented, in accordance with various embodiments herein.

FIG. 2 depicts an exemplary implementation of a computer system for intelligent short-term rental/lending coordination to determine one or more items associated with a party based upon aggregated party data, in accordance with various embodiments herein.

FIG. 3 depicts an exemplary implementation of a computer system for intelligent short-term rental/lending coordination to generate sets of associated parties for each item of one or more items, in accordance with various embodiments herein.

FIG. 4 depicts a flow diagram representing an exemplary computer-implemented method for intelligent short-term rental/lending coordination, in accordance with various embodiments herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

### Overview

The computer systems and methods disclosed herein generally relate to, inter alia, methods and systems for intelligent short-term rental or lending coordination for a plurality of parties via a ML and/or AI chatbot.

The systems and methods of the present disclosure may generally enable a coordination between parties for short-term rental or lending (also referenced herein as “short-term rental”) of items by a ML chatbot, and in certain embodiments, an AI chatbot (or voice bot). The ML/AI chatbot may be trained with a plurality of training party data from a plurality of training parties as input to output a plurality of training items associated with the plurality of training parties. In certain embodiments, the ML/AI chatbot may determine (i) one or more items a party owns and may be able to rent or lend, and (ii) parties in need of similar items based upon aggregated data from the parties. The ML/AI chatbot may then generate pairings or associations between respective parties based upon the items.

Moreover, and in some embodiments, generative artificial intelligence (AI) models (also referred to as generative machine learning (ML) models) including voice bots or chatbots may be configured to utilize artificial intelligence and/or machine learning techniques. Data input into the voice bots, chatbots, or other bots may include historical insurance claim data, historical home data, historical water damage data, sensor information, damage mitigation and prevention techniques, and other data. The data input into the bot or bots may include text, documents, and images, such as text, documents and images related to homes, claims, and water damage, damage mitigation and prevention, and sensors. In certain embodiments, a voice or chatbot may be a ChatGPT chatbot. The voice or chatbot may employ supervised or unsupervised machine learning techniques, which may be followed by, and/or used in conjunction with, reinforced or reinforcement learning techniques. In one aspect, the voice or chatbot may employ the techniques utilized for ChatGPT. The voice bot, chatbot, ChatGPT-based bot, ChatGPT bot, and/or other such generative model may generate audible or verbal output, text or textual output, visual or graphical output, output for use with speakers and/or display screens, and/or other types of output for user and/or other computer or bot consumption.

### Exemplary Computing Environment

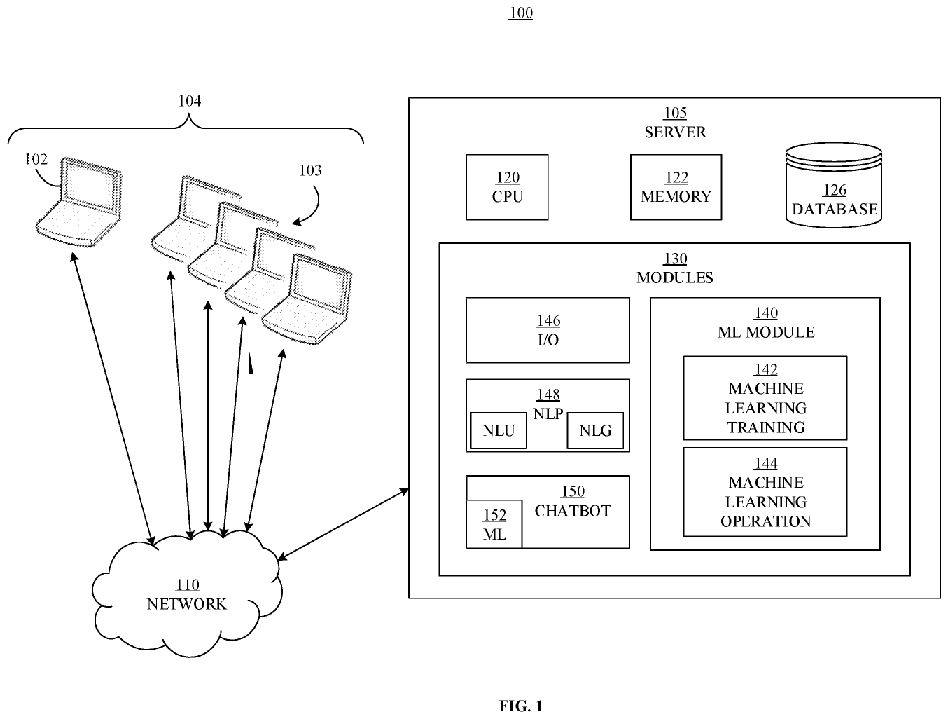

FIG. 1 depicts an exemplary computing environment 100 in which intelligent short-term rental or lending coordination may be performed, in accordance with various aspects discussed herein.

In the exemplary aspect of FIG. 1, the computing environment 100 includes a plurality of user devices 104. In various aspects, the plurality of user devices 104 may comprise a user device 102 and a plurality of other user devices 103. In various aspects the user device 102 and/or the plurality of other user devices 103 comprises one or more computers which may comprise multiple, redundant, or replicated client computers accessed by one or more users. The computing environment 100 may further include an electronic network 110 communicatively coupling other aspects of the computing environment 100. As described herein, the user device 102 may be representative of any of the user devices comprised in the plurality of user devices 104. As referenced herein, a “plurality of user devices” may also be referenced as a “plurality of electronic devices” or “party devices,” a “user device” may also be referenced as a “first party device,” and a “plurality of other user devices” may also be referenced as “other party devices.”

The user device 102 may be any suitable device and include one or more mobile devices, wearables, smart watches, smart contact lenses, smart glasses, augmented reality glasses, virtual reality headsets, mixed or extended reality glasses or headsets, voice bots or chatbots (e.g., chatbot 150), ChatGPT bots, and/or other electronic or electrical component. The user device 102 may include a memory and a processor for, respectively, storing and executing one or more modules. The memory may include one or more suitable storage media such as a magnetic storage device, a solid-state drive, random access memory (RAM), etc. The user device 102 may access services or other components of the computing environment 100 via the network 110.

Broadly speaking, the one or more servers 105 may be communicatively coupled to the user device 102 via the network 110 and may be configured to perform some/all of the functionalities described herein as part of the intelligent short-term rental or lending coordination. In certain aspects, the one or more servers 105 may be part of and/or otherwise operate within a cloud network or may otherwise communicate with other hardware or software components within one or more cloud computing environments to send, retrieve, or otherwise analyze data or information described herein. For example, in certain aspects of the present techniques, the computing environment 100 may comprise an on-premise computing environment, a multi-cloud computing environment, a public cloud computing environment, a private cloud computing environment, and/or a hybrid cloud computing environment, each of which are generally configured to provide the intelligent short-term rental or lending coordination system described herein.

For example, any suitable entity (e.g., a business) offering such an intelligent short-term rental or lending coordination system may host one or more services in a public cloud computing environment (e.g., Alibaba Cloud, Amazon Web Services (AWS), Google Cloud, IBM Cloud, Microsoft Azure, etc.). The public cloud computing environment may be a traditional off-premise cloud (i.e., not physically hosted at a location owned/controlled by the business). Additionally, or alternatively, aspects of the public cloud may be hosted on-premise at a location owned/controlled by an enterprise associated with the intelligent coordination for short-term rental or lending of items. The public cloud may be partitioned using visualization and multi-tenancy techniques and may include one or more infrastructure-as-a-service (IaaS) and/or platform-as-a-service (PaaS) services.

The network 110 may comprise any suitable network or networks, including a local area network (LAN), wide area network (WAN), Internet, or combination thereof. For example, the network 110 may include a wireless cellular service (e.g., 4G, 5G, etc.). Generally, the network 110 enables bidirectional communication between the user device 102 and the servers 105. In certain aspects, network 110 may comprise a cellular base station, such as cell tower(s), communicating to the one or more components of the computing environment 100 via wired/wireless communications based upon any one or more of various mobile phone standards, including NMT, GSM, CDMA, UMMTS, LTE, 5G, or the like. Additionally, or alternatively, network 110 may comprise one or more routers, wireless switches, or other such wireless connection points communicating to the components of the computing environment 100 via wireless communications based upon any one or more of various wireless standards, including by non-limiting example, IEEE 802.11a/b/c/g (WIFI), Bluetooth, and/or the like.

The processor 120 may include one or more suitable processors (e.g., central processing units (CPUs) and/or graphics processing units (GPUs)). The processor 120 may be connected to the memory 122 via a computer bus (not depicted) responsible for transmitting electronic data, data packets, or otherwise electronic signals to and from the processor 120 and memory 122 in order to implement or perform the machine-readable instructions, methods, processes, elements or limitations, as illustrated, depicted, or described for the various flowcharts, illustrations, diagrams, figures, and/or other disclosure herein. The processor 120 may interface with the memory 122 via a computer bus to execute an operating system (OS) and/or computing instructions contained therein, and/or to access other services/aspects. For example, the processor 120 may interface with the memory 122 via the computer bus to create, read, update, delete, or otherwise access or interact with the data stored in the memory 122 and/or a database 126.

The memory 122 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 122 may store an operating system (OS) (e.g., Microsoft Windows, Linux, UNIX, etc.) capable of facilitating the functionalities, apps, methods, or other software as discussed herein. The memory 122 may store a plurality of computing modules 130, implemented as respective sets of computer-executable instructions (e.g., one or more source code libraries, trained ML models such as neural networks, convolutional neural networks, etc.) as described herein.

In general, a computer program or computer based product, application, or code (e.g., the model(s), such as ML models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 120 (e.g., working in connection with the respective operating system in memory 122) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The database 126 may be a relational database, such as Oracle, DB2, MySQL, a NoSQL based database, such as MongoDB, or another suitable database. The database 126 may store data and be used to train and/or operate one or more ML/AI models, chatbots 150, and/or voice bots.

In one aspect, the computing modules 130 may include an ML module 140. The ML module 140 may include ML training module (MLTM) 142 and/or ML operation module (MLOM) 144. In some embodiments, at least one of a plurality of ML methods and algorithms may be applied by the ML module 140, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning.

In certain aspects, the ML based algorithms may be included as a library or package executed on server(s) 105. For example, libraries may include the TensorFlow based library, the Pytorch library, and/or the scikit-learn Python library.

In one embodiment, the ML module 140 employs supervised learning, which involves identifying patterns in existing data to make predictions about subsequently received data. Specifically, the ML module 140 is “trained” (e.g., via MLTM 142) using training data, which includes example inputs and associated example outputs. Based upon the training data, the ML module 140 may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiments, a processing element may be trained by providing it with a large sample of data with known characteristics or features.

In another embodiment, the ML module 140 may employ unsupervised learning, which involves finding meaningful relationships in unorganized data. Unlike supervised learning, unsupervised learning does not involve user-initiated training based upon example inputs with associated outputs. Rather, in unsupervised learning, the ML module 140 may organize unlabeled data according to a relationship determined by at least one ML method/algorithm employed by the ML module 140. Unorganized data may include any combination of data inputs and/or ML outputs as described above.

In yet another embodiment, the ML module 140 may employ reinforcement learning, which involves optimizing outputs based upon feedback from a reward signal. Specifically, the ML module 140 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The MLTM 142 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The MLOM 144 may comprise a set of computer-executable instructions implementing ML loading, configuration, initialization and/or operation functionality. The MLOM 144 may include instructions for storing trained models (e.g., in the electronic database 126). As discussed, once trained, the one or more trained ML models may be operated in inference mode, whereupon when provided with de novo input that the model has not previously been provided, the model may output one or more predictions, classifications, etc., as described herein.

In certain aspects, the computing modules 130 may include an input/output (I/O) module 146, comprising a set of computer-executable instructions implementing communication functions. The I/O module 146 may include a communication component configured to communicate (e.g., send and receive) data via one or more external/network port(s) to one or more networks or local terminals, such as computer network 110 and/or the user device 102 (for rendering or visualizing) described herein. In certain aspects, servers 105 may include a client-server platform technology such as ASP.NET, Java J2EE, Ruby on Rails, Node.js, a web service or online API, responsive for receiving and responding to electronic requests.

I/O module 146 may further include or implement an operator interface configured to present information to an administrator or operator and/or receive inputs from the administrator and/or operator. An operator interface may provide a display screen. I/O module 146 may facilitate I/O components (e.g., ports, capacitive or resistive touch sensitive input panels, keys, buttons, lights, LEDs), which may be directly accessible via, or attached to, servers 105 or may be indirectly accessible via or attached to the user device 102. According to an aspect, an administrator or operator may access the servers 105 via a user device (e.g., 104) to review information, make changes, input training data, initiate training via the MLTM 142, and/or perform other functions (e.g., operation of one or more trained models via the MLOM 144).

In certain aspects, the computing modules 130 may include one or more NLP modules 148 comprising a set of computer-executable instructions implementing NLP, natural language understanding (NLU) and/or natural language generator (NLG) functionality. The NLP module 148 may be responsible for transforming the user input (e.g., unstructured conversational input such as speech or text) to an interpretable format. The NLP module may include NLU processing to understand the intended meaning of utterances, among other things. The NLP module 148 may include NLG which may provide text summarization, machine translation, and dialog where structured data is transformed into natural conversational language (i.e., unstructured) for output to the user.

In certain aspects, the computing modules 130 may include one or more chatbots and/or voice bots 150 which may be programmed to simulate human conversation, interact with users, understand their needs and/or intentions, and recommend an appropriate line of action with minimal and/or no human intervention, among other things. This may include providing a best/optimal determined response corresponding to received queries and/or asking follow-up questions.

In some embodiments, the voice bots or chatbots 150 discussed herein may be configured to utilize ML and/or AI techniques. For instance, the voice bot or chatbot 150 may be a ChatGPT chatbot. The voice bot or chatbot 150 may employ supervised or unsupervised machine learning techniques, which may be followed by, and/or used in conjunction with, reinforced or reinforcement learning techniques. The voice bot or chatbot 150 may employ the techniques utilized for ChatGPT.

Noted above, in some embodiments, a chatbot 150 or other computing device may be configured to implement ML, such that server 105 “learns” to analyze, organize, and/or process data without being explicitly programmed. ML may be implemented through ML methods and algorithms (“ML methods and algorithms”). In one exemplary embodiment, the ML module 140 may be configured to implement ML methods and algorithms.

For example, in some aspects, the server 105 may receive a list of items over the network 110 from a user (e.g., a first party) via a user device 102, e.g., so the user may indicate items the user desires or possesses. The list of items may be processed using NLP module 148 and/or ML module 140 via one or more ML models to recognize what the user has included in the list of items or requested items, understand the meaning of the listed/requested items, determine an appropriate action, and/or respond (e.g., initiate contact with other parties, inform the user of determined insurance policies, perform an auction between two or more other parties) with language the user can understand.

The server 105 may further aggregate party data over the network 110 from a plurality of users (e.g., other parties) via a plurality of user devices (not shown) by scraping data from personal accounts (e.g., email, social media, text messages, photos) associated to the plurality of users. The chatbot 150 may subsequently determine one or more items associated with each party of the plurality of parties, i.e., the input from the plurality of users from which the chatbot 150 needs to generate a set of associated parties based upon items associated with each user. The party data may be processed using NLP module 148 and/or ML module 140 via one or more ML models to recognize what the data is/says, understand implications and/or other indications of the data, determine an appropriate action(s), and/or respond (e.g., send a list of items to the user, perform an auction with users, initiate contact between users) with language the user can understand.

In some aspects, the server 105 may host and/or provide an application (e.g., a mobile application) and/or website configured to enable the application to aggregate data (e.g., party data) from the user, send lists (e.g., list of items) to a user, receive signals (e.g., response signals, exchange terms, auction bids) from a user, and/or initiate contact between users (e.g., between parties, between party computing devices, between party voice or chat bots, during an auction). In an aspect, the server 105 may store code in memory 122 which when executed by CPU 120 may provide the website and/or application.

In one aspect, the application may use the chatbot 150 to determine one or more items from aggregated data (party data) associated with a user (e.g., a first party) and/or a plurality of users (e.g., a plurality of parties) to subsequently generate a set of associated users (e.g., associated parties) that includes at least a pair of users from the user and/or the plurality of users for each item of the one or more items. Data associated with the coordination (e.g., intelligent coordination via the AI/ML chat or voice bot) between users may be captured by the server 105 as coordinating data. In certain aspects, the server 105 may store the coordinating data in the database 126. The data may be cleaned, labeled, vectorized, weighted and/or otherwise processed, especially processing suitable for data used in any aspect of ML.

In a further aspect, anytime the server 105 evaluates a coordination (e.g., response signals, success of determined items from aggregate data, success of sets of associated parties, success of insurance policies), the associated information may be stored in the database 126. In some aspects, the server 105 may use the stored data and/or coordinating data to generate, train and/or retrain one or more ML models and/or chatbots 150, and/or for any other suitable purpose.

In operation, MLTM 142 may access the database 126 or any other data source for training data suitable to generate one or more ML models appropriate to intelligent coordination of short-term rental or lending of items, e.g., an ML chatbot 152. The training data may be sample data with assigned relevant and comprehensive labels (classes or tags) used to fit the parameters (weights) of an ML model with the goal of training it by example.

In certain aspects, training data may include historical data from past coordinations (e.g., previous instances of intelligent short-term rental or lending coordination between a plurality of parties). The historical data may include aggregate data from users, determined items, lists of items, sets of associated users, exchange terms, demand of items, auction results, insurance policies for items, accountability scores of users (indicating likelihood of items being lost or damaged if lent/rented), commonality values (e.g., values associated with social media commonality, geographic commonality, risk commonality based upon risk tolerance, experience commonality based upon rental/lending experience, accountability commonality based upon accountability scores, compatibility value indicating overall compatibility of parties), response signals from users, anonymized information, whether a contractual agreement was finalized, as well as any other suitable training data or combinations thereof.

In some aspects, once an appropriate ML model is trained and validated to provide accurate predictions and/or responses, e.g., the ML chatbot 152 generated by MLTM 142, the trained model and/or ML chatbot 152 may be loaded into MLOM 144 at runtime, may process the user inputs (e.g., party data, list of items, response signals) and may generate outputs (e.g., sets of associated users, contact between users, auctions between users, exchange terms, accountability scores, commonality values, finalized contractual agreements, insurance policies). The outputs may be generated as conversational dialog in written and/or verbal form, and/or may be or include any other suitable output format.

While various embodiments, examples, and/or aspects disclosed herein may include training and generating one or more ML models and/or ML chatbot 152 for the server 105 to load at runtime, it is also contemplated that one or more appropriately trained ML models and/or ML chatbot 152 may already exist (e.g., in database 126) such that the server 105 may load an existing trained ML model and/or ML chatbot 152 at runtime. It is further contemplated that the server 105 may retrain, update and/or otherwise alter an existing ML model and/or ML chatbot 152 before loading the model at runtime.

Although the computing environment 100 is shown to include one user device 102, one server 105, and one network 110, it should be understood that different numbers of user devices 102, networks 110, and/or servers 105 may be utilized. In one example, the computing environment 100 may include a plurality of servers 105 and hundreds or thousands of user devices 102, all of which may be interconnected via the network 110. Furthermore, the database storage or processing performed by the one or more servers 105 may be distributed among a plurality of servers 105 in an arrangement known as “cloud computing.” This configuration may provide various advantages, such as enabling near real-time uploads and downloads of information as well as periodic uploads and downloads of information.

The computing environment 100 may include additional, fewer, and/or alternate components, and may be configured to perform additional, fewer, or alternate actions, including components/actions described herein. Although the computing environment 100 is shown in FIG. 1 as including one instance of various components such as user device 102, server 105, and network 110, etc., various aspects include the computing environment 100 implementing any suitable number of any of the components shown in FIG. 1 and/or omitting any suitable ones of the components shown in FIG. 1. For instance, information described as being stored at server database 126 may be stored at memory 122, and thus database 126 may be omitted. Moreover, various aspects include the computing environment 100 including any suitable additional component(s) not shown in FIG. 1, such as but not limited to the exemplary components described above. Furthermore, it should be appreciated that additional and/or alternative connections between components shown in FIG. 1 may be implemented. As just one example, server 105 and user device 102 may be connected via a direct communication link (not shown in FIG. 1) instead of, or in addition to, via the network 130.

Exemplary Intelligent Short-Term Rental/Lending Coordination within the Exemplary Computing Environment

In some aspects, a plurality of parties may desire to rent or lend items in their possession and/or rent or borrow items in other parties' possession. A party, of the plurality of parties may use the user device 102 to access a mobile application (app) provided by an enterprise. The party may sign into the application using their user credentials. The user credentials may be transmitted by the user device 102 via network 110 to the enterprise's server 105. The server 105 may verify the party's credentials, e.g., using the party's profile data saved on database 126. Upon verification of the credentials by the server 105, the app may provide the party access to one or more business functions associated with the enterprise, one of which may include intelligent short-term rental or lending coordination. The party may select an app icon on the display of their user device 102 associated with intelligent short-term rental or lending coordination. Based upon a request for intelligent short-term rental or lending coordination, the server 105 may initiate a session (coordinating session) with the user device 102. Data determined, generated, received, or otherwise associated with the coordinating session may be stored by the server 105 as coordinating data on database 126. The server 105 may also initiate a coordinating session with the user device 102 without the party using an app. For example, the server 105 may receive a text message from the party indicating a request for intelligent short-term rental or lending coordination.

Communication during the coordinating session between the plurality of parties, their respective user devices (e.g., user device 102) of the plurality of user devices 104, the server 105, and any combinations therein, may include one or more of (i) audio (e.g., a telephone call), (ii) text messages (e.g., short messaging/SMS, multimedia messaging/MMS, iPhone iMessages, etc.), (iii) instant messages (e.g., real-time messaging such as a chat window), (iv) video such as video conferencing, (v) communication using virtual reality, (vi) communication using augmented reality, (vii) blockchain entries, (vii) communication in the metaverse, and/or any other suitable form of communication or combinations thereof.

In some aspects, the server 105 may aggregate party data from the plurality of parties on database 126 via a party's user device (e.g., electronic devices, user device 102). Party data may be any data indicating items a party owns or desires, and be of any file format (e.g., file types). In some aspects, the party data is stored on the electronic devices (e.g., plurality of user devices 104) respectively associated with each party of the plurality of parties. For example, a first party may have a list of desired items stored on a text manipulator application (e.g., notes app, Microsoft Word) stored on the user device 102. The first party may then initiate a coordinating session via the app and may grant permissions to the server 105 to access data (i.e., party data) stored on the user device 102, including the list of desired items on the text manipulator app. The server 105 may then aggregate the list of desired items (i.e., data, party data) from the text manipulator app and store the list of desired items as party data on the database 126. Party data may be similarly aggregated from each party of the plurality of parties and stored on the database 126.

In some aspects, the server 105 may aggregate party data by scraping data from one or more personal accounts associated with the respective parties. Personal accounts may include, for example, (i) email account(s) (e.g., Gmail, Yahoo! Mail), (ii) social media account(s) (e.g., Instagram, GoodReads, Twitter), (iii) text messages, (iv) voice messages, (v) voice mails, (vi) voice memos, (vii) photos, (viii) electronic calendars, and/or any other data personal to the associated party to be utilized by the methods herein. For example, a first party may send a text message indicating their lawn mower recently broke. The server 105 may scrape the data from the text message and aggregate it with other party data scraped from personal accounts of the first party and/or other parties and store the party data on database 126.

Once the server 105 has aggregated party data, the server 105 may determine one or more items associated with each party of the plurality of parties via a chatbot 150. The chatbot 150 may be the ML chatbot 152, an AI chatbot such as a ChatGPT chatbot and/or any other suitable chatbot described herein. In some aspects, the ML chatbot 152 may be hosted on a ChatGPT server (not illustrated). The server 105 may select an appropriate chatbot 150 based upon the type of party data, one or more pieces of information provided by one or more of the parties to the server 105 (e.g., list of items, response signals), and/or other aspects of coordinating short-term rental or lending. In one example, the server 105 may train (e.g., via ML module 140 and/or MLTM 142) the ML chatbot 152 to handle specific types of party data. For example, a chatbot 150 may be trained to handle audio file formats (e.g., MP3, WAV), or photo file formats (e.g., JPEG, PNG, HEIC). In some aspects, the server 105 may additionally, or alternatively, use the NLP module 148 (which may include NLU and/or NLG) to process the aggregated party data. In certain aspects, the server 105 may determine one or more items associated with each party of the plurality of parties using the NLP module 148 to understand the natural language of aggregated party data.

One or more items associated with a party may include items personally or jointly owned by the party and/or items the party may need or desire. For example, a family may frequently camp together. There may be pictures of the family around a towable trailer twice a year, social media posts about the camping trip, a review written from a family member's customer account rating a tent that broke after one use, calendar events indicating the camping trip dates, text messages asking a family member to pick up the trailer and camping gear from storage, and a voicemail reminding the family member to pick up the fishing poles from the storage facility as well, all on the plurality of user devices 104. Items associated with the family may include the towable trailer, the tent, camping gear, space in the storage facility, and fishing poles. Because each of the items have left a digital trace (i.e., data) of the family's association to the item on the plurality of user devices 104 used by the family, the data of each item may be aggregated as party data and used by the server 105 to determine an item and associate it with the respective party (i.e., family). In this example, the trailer, camping gear, space in a storage facility, and fishing poles may be associated to the family by the server 105 as items the family owns. However, the tent may be associated to the family by the server 105 as an item the family needs.

In some aspects, chatbot 150 may be trained using a plurality of training party data from a plurality of training parties as input to output a plurality of training items associated with the plurality of training parties. Continuing the previous example, the plurality of training party data may be JPEG files of the family camping, a CSV file of the calendar event, an MSG file of the text message, and an MP3 file of the voicemail. The plurality of training items may include the trailer, camping gear, space at a storage facility, and fishing poles. Any methods of training may be used including those described elsewhere herein. The output of a trained chatbot (e.g., ML chatbot 152) may be the chatbot 150 determining the identity of one or more items associated with the party data (and therefore the party) the determination was based upon. Generally, the one or more items may be stored on database 126 as coordinating data.

Once items are respectively associated with the plurality of parties, the server 105 may generate via the chatbot 150 a set of associated parties that includes at least a pair of parties from the plurality of parties for each item of the one or more items. For example, a first party may have sent a text message to a friend indicating their lawnmower recently broke down, a second party may have received a receipt to their email address for a lawnmower they purchased, and the respective data may have been aggregated by server 105 as party data on database 126. The server 105 may determine the lawnmower as an item associated with both the first and second party and generate a set of parties associated with a lawnmower, including the first and second parties as a pair.

In aspects where the server 105 generates a set of associated parties, the server 105 may initiate contact between parties for each set of associated parties. In some aspects, this may include initiating contact between the parties themselves (e.g., by exchanging contact information such as email addresses or telephone numbers), party user devices (e.g., user device 102, other user devices 103), party voice or chatbots (e.g., a chatbot trained by a first party to facilitate correspondence with other parties on the first party's behalf), and/or any combination therein.

In some aspects the server 105 may anonymize contact between respective parties from the set of associated parties and additionally, or alternatively, anonymize via the chatbot 150 identifying information of each party of the plurality of parties. The server 105 may anonymize contact between respective parties by any means that would allow parties to exchange information regarding the associated item without disclosing personal information about either party to the other. For example, server 105 may assign temporary email addresses to each party to facilitate conversation and provide each party with necessary information to access the email address, or the server 105 may anonymize contact via the app by establishing a chat between the respective parties on the app. Additionally, or alternatively, the server 105 may anonymize identifying information of each party by any means that would disassociate the identity of a party from identifying information (i.e. party data, coordinating data) utilized by the system and methods herein to coordinate short-term rental or lending. For example, the server may use the chatbot 150 trained on training party data, training identifying information and training anonymized party data to scramble identifying information (e.g., receipts for medication prescriptions) and disassociate the identifying information from the party.

In some aspects, the plurality of parties may include a first party and a plurality of other parties, and the server 105 may receive a list of one or more items from the first party, aggregate party data from the plurality of other parties, and determine via the chatbot 150 one or more items associated with each party of the plurality of other parties. The first party may use the user device 102 to initiate a coordinating session and send the list of one or more items to the server 105. The plurality of other parties may use the other user devices 103 to initiate a coordinating session and the server may aggregate party data from the plurality of other parties via the other user devices 103. After determining one or more items associated with each party of the plurality of parties, the server 105 may subsequently generate via the same or different chatbot 150 a set of associated parties based upon the one or more items associated with each party of the plurality of other parties and the one or more items received from the first party. The chatbot 150 may be trained using sets of associated parties and associated items from previous coordinating sessions and may be the ML chatbot 152. The server 105 may subsequently initiate contact with the first party and every associated party in the set.

For example, a first party may want to lend out their pottery wheel to one or more users in their community. The first party may use the user device 102 to send a list of items, including the pottery wheel, to the server 105 via the app. The server 105 may aggregate party data from a plurality of other parties via the other user devices 103 and determine via a chatbot 150 a pottery wheel to be one of the one or more items associated with particular parties of the plurality of other parties. The server 105 may subsequently generate via the chatbot 150 a set of associated parties based upon the pottery wheel item listed by the first party, and the pottery wheel associated with particular parties. The server 105 may subsequently initiate contact between the first party and the particular parties (other parties associated with a pottery wheel) from the set via the user device 102 and any of the other user devices 103 associated with a particular party of the plurality of other parties.

In some aspects, the server 105 may generate the set of associated parties based upon a response signal. In these aspects the server 105 may send a list of items to a first party from the plurality of parties via the user device 102 and subsequently receive a response signal from the first party via the user device 102 indicating, for each item from the list of items, information about the item. Information may include one or more of (i) a listed item is not owned by the first party, (ii) a listed item is owned by the first party, (iii) a listed item is owned by the first party and is available for renting, (iv) a listed item is not needed by the first party, (v) a listed item is needed by the first party and the first party does not need the item immediately, or (vi) a listed item is needed by the first party and the first party needs the listed item immediately. The server 105 may generate the set of associated parties via chatbot 150 trained on training response signals and training sets of associated parties additionally, or alternatively, to training party data and a plurality of training items associated with a plurality of training parties. In certain aspects, the server 105 may send the list of items in a natural language format by using NLP module 148. In certain aspects, the server 105 may additionally, or alternatively, use the NLP module 148 to process the response signal. In any event, the server 105 may store response signals as coordinating data on database 126.

For example, a first party may be associated with a jet ski and receive a list of items from the server 105 via a text message to the user device 102 which lists a jet ski as an item. The first party may send a response signal to the server 105 via a text message from the user device 102 indicating they do not own a jet ski, nor do they have a need for a jet ski. The server 105 may use NLP module 148 to process the response signal, and chatbot 150 to generate a set of parties associated with a jet ski wherein the first party is not included in the set.

In some aspects, the server 105 may generate the set of associated parties based upon one or more commonality values such as (i) a social media commonality value; (ii) a geographic commonality value indicating a similarity of geographic location among/between associated parties; (iii) a risk commonality value indicating a similarity of risk tolerance among/between associated parties; (iv) an experience commonality value indicating a similarity of successful rentals among/between associated parties; (v) an accountability commonality value indicating a similarity of accountability scores among/between associated parties, the accountability scores indicating a likelihood of items from the one or more items becoming damaged once exchanged, (vi) a compatibility value indicating the overall compatibility between/among associated parties, and/or any value that may be used to indicate whether two parties may compatibly coordinate for a short-term rental or lending of an item. A commonality value may be a value based upon comparing metrics of each party to determine a single value indicating the compatibility of the parties (e.g., a first and second party). A commonality value may additionally, or alternatively, be a value based upon comparing a score (e.g., accountability score) of an individual party (e.g., a first party) to a score of another individual party (e.g., a second party) to indicate the compatibility of both parties (e.g., a first and second party).

For example, the social media commonality value of a first party may be a social media score indicating the party's presence on social media, use of hate speech on social media, or likelihood for the party's social media to be fake or contain conflicting information. A social media score for a second party may be compared to the social media score of the first user and the compared social media scores may be used by the server 105 to determine a social media commonality value used to generate the set of associated parties. Additionally, or alternatively, the social media commonality value may be a value indicating the compatibility of the first and second parties based upon metrics of the first and second parties together, such as the number of common friends, and/or friends of friends, on social media.

The geographic commonality value may be a score indicating the first party's geographic location (e.g., GPS coordinates) compared to a score indicating the second party's geographic location for a resultant geographic commonality value. Additionally, or alternatively, the geographic commonality value may be, for example, a binary value indicating whether the first or second party are in the same county, or, e.g., within a 10-mile radius of each other.

A commonality value may be based upon respective party data for each party of the plurality of parties. For example, the risk commonality value may be a score indicating the first party's risk tolerance compared to a score indicating the second party's risk tolerance. Party data indicating risk tolerance may include, e.g., a voice message referencing an event as too risky, a receipt for travelers' insurance, an email indicating a decreased credit score, etc.

A commonality value may be based upon coordinating data associated with previous coordinating sessions. For example, the experience commonality value may indicate a similarity of successful rentals among/between associated parties and be based upon the number of previous coordinating sessions initiated with the server 105 by a party via the app and the respective coordinating data indicating whether the party completed the rental of the coordinating session. The number of previous/successful coordinating sessions of each party may be considered scores and compared to determine a resultant experience commonality value. In another example, the risk commonality value may be based upon the risk commonality score of a previous coordinating session which the server 105 may have stored as coordinating data in database 126.

A commonality value may be based upon one or more other commonality values. For example, the accountability commonality value may indicate a similarity of accountability scores between/among the first and second party. The accountability score may be based upon the experience commonality value and the geographic commonality value, as parties with more experience and who live closer together may be more likely to return a rented item. In another example, the compatibility value may be based upon the social media commonality value, the geographic commonality value, the risk commonality value, the experience commonality value, the accountability commonality value, and/or party/coordinating data.

In some aspects, the server 105 may generate, via the chatbot 150, one or more exchange terms for each of the one or more items associated with each party of the plurality of parties. The chatbot 150 may be trained on aggregated party data and/or one or more items, and exchange terms associated with the respective party. The exchange terms may include one or more of (i) a length of time of a rental period (e.g., 1 hour, 2 weeks), (ii) a compensation value (e.g., $50, 0.03 bitcoin, exchange of item of similar value, free), (iii) a security deposit value (e.g., $50, repossessing driver's license of borrower until item is returned), (iv) an insurance policy requirement (e.g., coverage under existing policy, purchasing a specific insurance policy for the short-term rental or lending), (v) a cash payment requirement (e.g., must be compensated with cash), (vi) a delivery requirement (e.g., pick-up only), and/or any exchange term which may indicate a party's likelihood to rent or lend/borrow an item. As described elsewhere herein, in certain aspects one or more items associated with a party may include a list of one or more items received by the server 105 from a party (e.g., a first party). Accordingly, the server 105 may generate exchange terms based upon the list of one or more items and/or party data associated with the party. In certain aspects, the server 105 may generate a plurality of exchange terms in a natural language format by using NLP module 148. For any aspect, exchange terms may be stored in the database 126 as coordinating data.

In some aspects, the server 105 may generate via the chatbot 150 the set of associated parties based upon the one or more exchange terms associated with each party. For example, a first and second party may be associated with a baseball bat. The first party may receive a text message to user device 102 asking if they want to practice hitting baseballs later that Friday evening. The first party may send a text message to their friend saying they don't know anyone who owns a baseball bat and send a list to the server 105 via the app which includes a baseball bat. The second party may have a picture of them opening a baseball bat for Christmas and an event on a calendar app on their electronic device (e.g., other user devices 103) for a home baseball game on the upcoming Sunday. The server 105 may determine the second party owns a baseball bat based upon party data and generate one or more exchange terms, including a rental period being 24 hours because the second party has a baseball game on Sunday. The server 105 may determine the first party needs a baseball bat based upon the received list of items and generate one or more exchange terms, including a rental period of less than 24 hours. The server 105 may then generate a set of associated parties which includes the first party and the second party based upon compatible exchange terms of renting or lending the baseball bat for a short period of time.

In some aspects the server 105 may generate/determine one or more exchange terms by determining via the chatbot 150 a demand value for a first item of the one or more items associated with a first party. The demand value may be based upon a first metric corresponding to parties of the plurality of parties associated with at least one item similar to the first item. Additionally, or alternatively, the demand value may be based upon a second metric corresponding to items from the one or more items that are similar to the first item.

For example, a lawnmower may be a first item of the one or more items associated with a first party. However, there may be a plurality of other parties also associated with a lawnmower. Depending on the availability or lack of availability (i.e., demand) of lawnmowers among the plurality of parties (the first party and the plurality of other parties), a first party may want to charge a fee for using their lawnmower instead of lending it due to a scarcity of parties with a lawnmower to rent or lend. Thus, the server 105 may use a demand value to generate exchange terms. The server 105 may determine a demand value via the chatbot 150 based upon a first or second metric. In this example, a first metric may correspond to the number of parties of the plurality of other parties owning or desiring at least one item similar to a lawnmower. A second metric may correspond to the number of items similar to a lawnmower out of each item associated with each party of the plurality of other parties. Accordingly, the exchange terms generated by the server 105 by determining a demand value may reflect the scarcity or abundance of lawnmowers, e.g., shorter rental period, increased cost for rental, requiring a insurance policy, requiring the lawnmower to be picked up by borrower.

The server 105 may determine a demand value based upon the first metric, second metric, or any metric that provides insight into the demand of the item among the plurality of parties and/or in the marketplace. Accordingly, chatbot 150 may be ML chatbot 152 trained on first items, respective one or more items and associated parties, demand values, and/or exchange terms. In any aspect the server 105 may store a demand value, first metric, and/or second metric in the database 126 as coordinating data.

In some aspects, the server 105 may determine an insurance policy to cover a first item of the one or more items and initiate an insurance policy acquisition procedure to secure the insurance policy for the first item. The insurance policy may be for items being rented out/lent to another party, or for a party renting/borrowing an item. For example, an exchange term requirement for a second party to rent their diamond necklace to a first party may be for the first party to have an insurance policy for the necklace. Accordingly, the server 105 may determine an insurance policy for the first party by accessing insurance policy data stored on database 126 or on an insurance company server (not shown) belonging to an insurance company and identifying a policy that covers jewelry. The server 105 may then initiate an insurance policy acquisition procedure with the insurance company server. Alternatively, the entity to which server 105 belongs may be an insurance company and server 105 may be configured to initiate insurance policy acquisition procedures.

In some aspects, the server 105 may determine the insurance policy by determining via the chatbot 150 an accountability score for the first party and determining an insurance policy based upon the accountability score. An accountability score may indicate the predicted/likely accountability of a party (e.g., first party) to comply with the exchange terms agreed upon by the parties involved (e.g., rental period, not damaging an item, returning a security deposit). Accordingly, the accountability of a party may influence insurance policy terms (e.g., premium cost) available to the party. Continuing the previous example, the first party may be a home-owning octogenarian looking for a necklace to wear to an event for one evening in the same state they live in. The server 105 may use chatbot 150 trained on training party data, training insurance policy data, and training accountability scores to determine an accountability score for the first party. An insurance company may publish/host a library on the insurance company server (not shown) indicating established premiums for parties depending on a party's accountability score. The server 105 may access the library and determine an insurance policy for the first party based upon the accountability score. Alternatively, the server 105 may store insurance policy data on database 126 that indicates insurance policies available to parties with various accountability scores. In any aspect, accountability scores may be stored on database 126 as coordinating data.

In some aspects a first item may be associated with a first party and the server 105 may determine two or more other parties of the plurality of parties associated with the first item. The server 105 may subsequently perform an auction between the two or more other parties for the first item. The auction may result in a second party from the two or more other parties being a winning party, and the server 105 may initiate contact between the winning party and the first party.

For example, a first party may be associated with a pottery wheel and the server 105 may determine via the chatbot 150 two or more other parties of the plurality of parties that are associated with a pottery wheel. The server 105 may then perform an auction between the two or more other parties by establishing an auction via the app. The two or more other parties may use electronic devices (e.g., other user devices 103) to place bids via the app for renting the pottery wheel and therefore participate in the auction. Alternatively, the server may perform an auction in any way that allows parties to place bids on the first item, e.g., the server 105 receiving/sending text messages. When a second party of the two or more parties places a highest bid without contention from another party, the second party wins the auction and becomes the winning party. The server 105 may subsequently initiate contact with between the winning party and the first party, e.g., by establishing a chat within the apps between respective user devices of the plurality of user devices 104. In some aspects, the server 105 may additionally, or alternatively, use the NLP module 148 (which may include NLU and/or NLG) to perform the auction by generating auctioneer bids in a natural language format.

In some aspects the server 105 may generate via chatbot 150 one or more exchange terms for each item of the one or more items. The chatbot 150 may be trained on training party data, a plurality of training items, and training exchange terms. The exchange terms may be similar to exchange terms described elsewhere herein. In certain aspects the server 105 may additionally, or alternatively, negotiate exchange terms between associated parties via chatbot 150. This may include the chatbot 150 being a voice or chatbot and communicating with the party via the party's electronic devices (e.g., plurality of user devices 104). For example, the chatbot 150 may negotiate with a party over voice or text to change the exchange terms until all exchange terms are acceptable to all associated parties. In certain aspects the server 105 may additionally, or alternatively, finalize a contractual agreement between the associated parties with agreed exchange terms. Agreed exchange terms may be exchange terms acceptable to all associated parties. For example, responsive to determining all associated parties agree to exchange terms (e.g., receiving a signal of completed negotiation), the chatbot 150 may finalize a contract between the associated parties by sending an electronic contract (e.g., DocuSign contract) to each party, and/or signing the contract on behalf of each party.

In some aspects, the server 105 may additionally, or alternatively, generate exchange terms, negotiate exchange terms, and/or finalize a contractual agreement between associated parties in a natural language format using the NLP module 148 (which may include NLU and/or NLG). In some aspects, the server 105 may additionally, or alternatively, use NLP module 148 to process exchange terms while negotiating exchange terms between associated parties.

### Exemplary Implementation of Intelligent Short-Term Rental/Lending Coordination

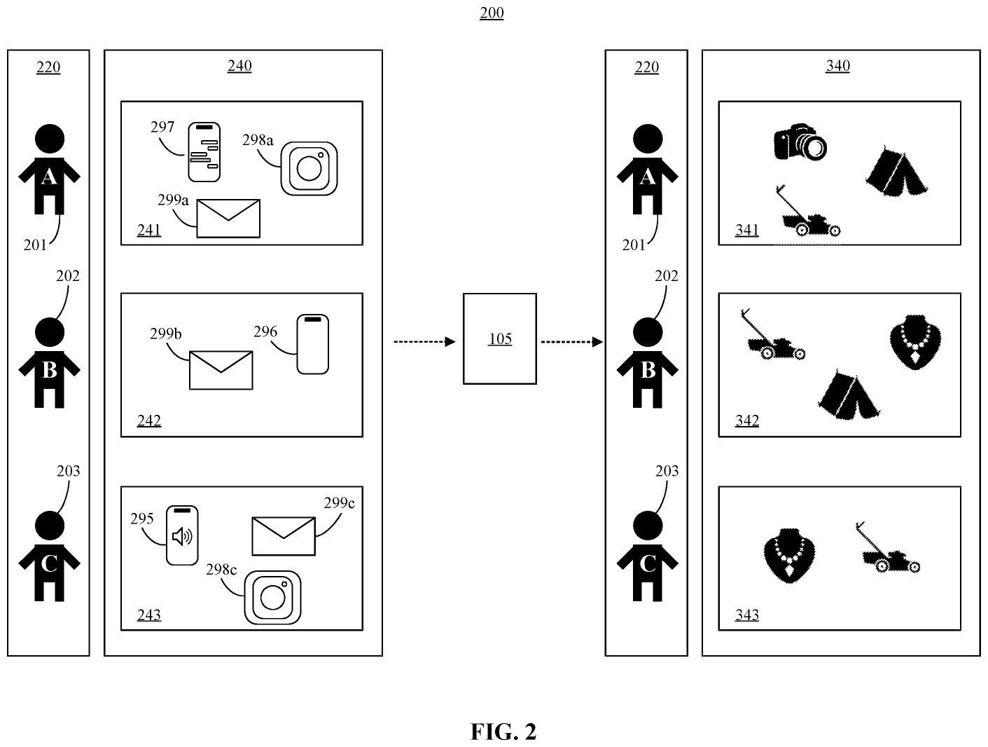

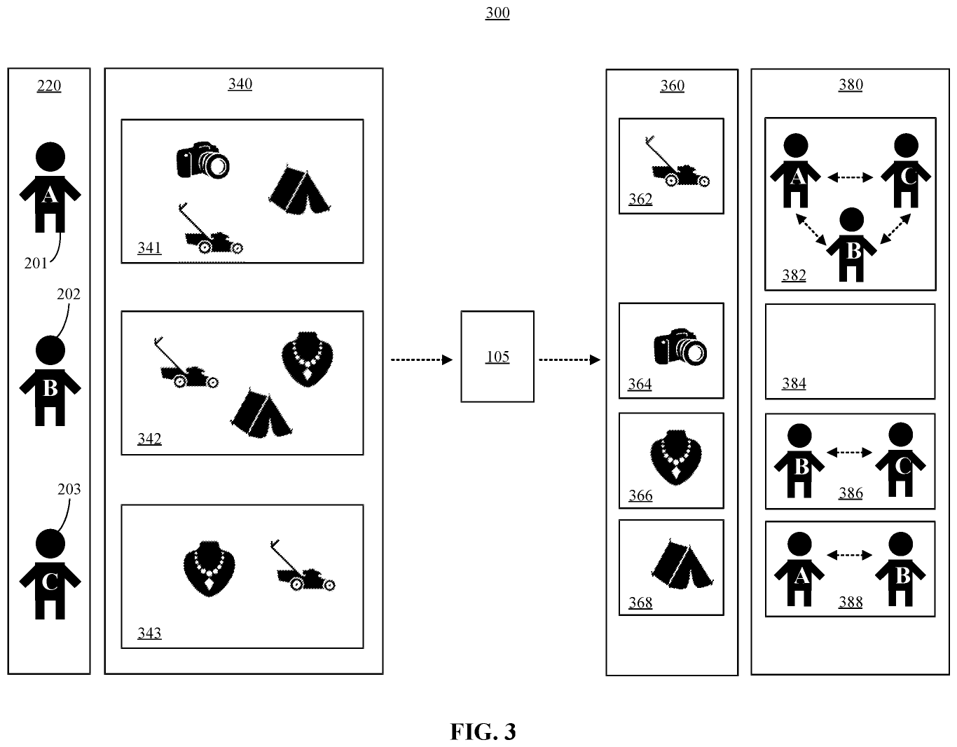

FIGS. 2 and 3 illustrate implementations 200 and 300, respectively, of the computing system 100 for short-term rental/lending coordination, in accordance with various embodiments described herein. In general, implementation 200 of FIG. 2 illustrates a plurality of parties 220, each with associated party data 240 and one or more items 340. In particular, FIG. 2 illustrates the server 105 determining one or more items 340 associated with each party (e.g., party 201, 202, 203) based upon aggregated party data 240.

For example, a plurality of parties 220 may include party 201, party 202, and party 203. The plurality of parties 220 may each be associated with party data 240. In this illustrative example, party 201 may be associated with party data 241, party 202 may be associated with party data 242, and party 203 may be associated with party data 243. Party data 240 may be aggregated from a respective party's electronic device (e.g., user device 102). In certain aspects, party data 240 may be scraped from one or more personal accounts associated with the respective party. In this illustrative example, party data 241 may include: (i) an email account 299a, (ii) a social media account 298a, and (iii) a text message account 297; party data 242 may include: (i) an email account 299b, and (ii) a voice mail account 296; and party data 243 may include: (i) an email account 299c, (ii) a social media account 298c, and (iii) a voice memo account 295. Data scraped from personal accounts of the plurality of parties 220 may be aggregated as party data (e.g., 241, 242, 243) associated with a party (e.g., 201, 202, 203).

In various aspects, the server 105 may utilize the party data 240 to determine one or more items 340 associated with the each of the plurality of parties 220. In this illustrative example, party 201 may be associated with items 341, party 202 may be associated with items 342, and party 203 may be associated with items 343. Items 341 may include a camera, a tent, and a lawnmower. Items 342 may include a lawnmower, a tent, and a diamond necklace. Items 343 may include a diamond necklace and a lawnmower.

For example, party 201 may have sent a text message from their text message account 297 indicating their lawnmower recently broke down, party 202 may have received a receipt to their email account 299b for a lawnmower they purchased, party 203 may have posted on their social media account 298c indicating their home is overgrown with weeds, and the respective data may have been aggregated as party data 240. Subsequently, the server 105 may determine the plurality of parties 220 as associated with one or more items 340, including a lawnmower, based upon the party data 240. The server 105 may thereafter generate sets of parties based upon one or more items 340 associated with the plurality of parties 220, as depicted in implementation 300 of FIG. 3.

In general, implementation 300 of FIG. 3 illustrates the plurality of parties 220, each associated with one or more items 340 and a set of associated parties 380 for each item 360. In particular, FIG. 3 illustrates the server 105 generating sets of associated parties 380 for each item 360 based upon one or more items 340 associated with each party of the plurality of parties 220.

For example, server 105 may generate a first set of associated parties 382 for item 362, a second set of associated parties 384 for item 364, a third set of associated parties 386 for item 366, and a fourth set of associated parties 388 for item 368. In this illustrative example, each party of the plurality of parties 220 may be associated with item 362 (e.g., a lawnmower). Accordingly, the server 105 may generate the first set of associated parties 382 including each party of the plurality of parties 220. In particular, the server 105 may pair party 201 with party 202 and 203, party 202 with party 201 and party 203, and party 203 with party 201 and party 202 to generate the first set of associated parties 382.

Similarly, party 202 and party 203 may be associated with item 366 (e.g., a necklace) and party 201 and party 202 may be associated with item 368 (e.g., a tent). Accordingly, the server 105 may generate the third set of associated parties 386 to include party 202 and party 203; and generate the fourth set of associated parties 388 to include party 201 and party 202. In the third set of associated parties 386, the server 105 may pair party 202 and party 203. In the fourth set of associated parties 388, server 105 may pair party 201 and party 202.

However, in some instances, an item may only be associated with a single party. For example, party 201 may solely be associated with item 364 (e.g., a camera). In these instances, the server 105 may generate an empty set 384 containing no pairs of associated parties and/or generate a set (not shown) with the sole associated party 201.

FIG. 3 further illustrates how, in various aspects, the server 105 may subsequently initiate contact between each party in a set of associated parties (e.g., 382, 386, 388). Namely, the server 105 may initiate contact between the associated parties through any suitable communication medium (e.g., email, social media, phone call, text message, webchat, etc.). By doing so, the server 105 may coordinate the short-term rental/lending of each item 360 of the one or more items 340 by enabling the associated parties to contact one another and/or automatically transmitting communications configured to engage in a short-term rental/lending of the associated items 360.

### Exemplary Methods for Intelligent Short-Term Rental/Lending Coordination

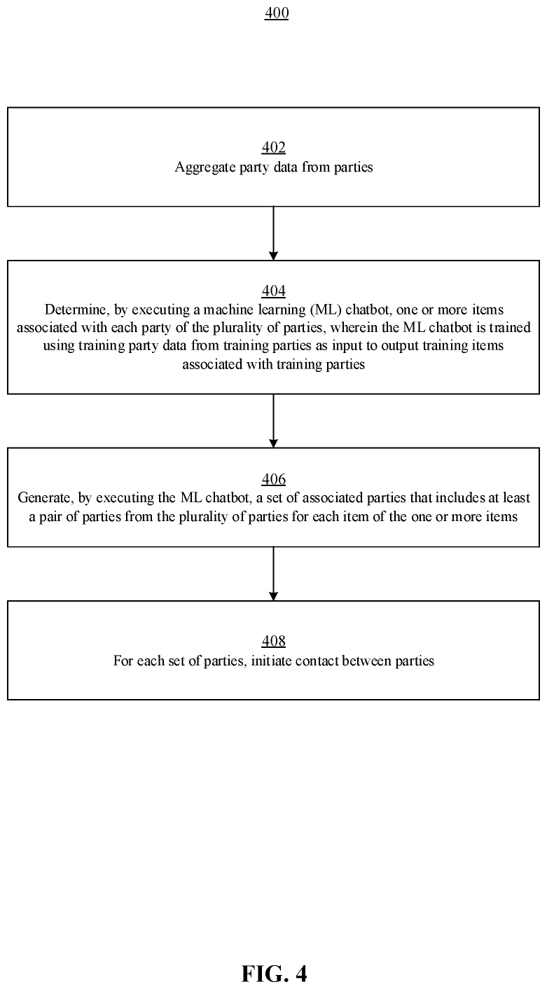

FIG. 4 depicts a flow diagram representing an exemplary computer-implemented method 400 for intelligent short-term rental/lending coordination, in accordance with various embodiments described herein. The method 400 may be implemented by a computing system 100 such as the server 105, the user device 102, the other user devices 103, and/or the plurality of user devices 104.

The method 400 may include aggregating party data from a plurality of parties (block 402). In some embodiments, party data may be aggregated by scraping data from one or more personal accounts associated with respective parties. Personal accounts may be or include one or more of: (i) email account(s), (ii) social media account(s), (iii) text messages, (iv) voice messages, (v) voice mails, (vi) voice memos, (vii) photos, or (viii) electronic calendars.

The method 400 may further include determining, by executing a machine learning (ML) chatbot, one or more items associated with each party of the plurality of parties (block 404). The ML chatbot may be trained using a plurality of training party data from a plurality of training parties as input to output a plurality of training items associated with the plurality of training parties.

The method 400 may further include generating, by executing the ML chatbot, a set of associated parties that includes at least a pair of parties from the plurality of parties for each item of the one or more items (block 406). In certain embodiments, the method 400 may further include generating, by executing the ML chatbot, one or more exchange terms for each of the one or more items. Further in these embodiments, the one or more exchange terms may include one or more of (i) a length of time of a rental period, (ii) a compensation value, (iii) a security deposit value, (iv) an insurance policy requirement, (v) a cash payment requirement, or (vi) a delivery requirement.

The method 400 may further include, for each set of parties, initiating contact between parties (such as between (i) parties, (ii) party computing devices; and/or (iii) party voice or chat bots) (block 408).

In various embodiments, the plurality of parties may include a first party and a plurality of other parties. In these embodiments, the method 400 may further include receiving a list of one or more items from a first party of the plurality of parties, aggregating party data from the plurality of other parties; determining, by executing a ML chatbot, one or more items associated with each party of the plurality of parties; generating, by executing the ML chatbot, a set of associated parties based upon the one or more items associated with each party of the plurality of other parties and the one or more items received from the first party, wherein the ML chatbot may be trained using historical sets of associated parties and associated items; and initiating contact with the first party and every associated party in the set.

In some embodiments, the method 400 may further include generating, by executing the ML chatbot, the set of associated parties based upon the one or more exchange terms associated with each party.

In certain embodiments, the method 400 may further include generating one or more exchange terms by determining, by executing the ML chatbot, a demand value for the first item based upon one or more of (i) a first metric corresponding to parties of the plurality of parties associated with at least one item similar to the first item, or (ii) a second metric corresponding to items from the one or more items that are similar to the first item.

In various embodiments, the method 400 may further include a first item associated with a first party and determining, by executing the ML chatbot, two or more other parties of the plurality of parties that are associated with the first item. In these embodiments the method 400 may further include performing an auction between the two or more other parties for the first item, the auction resulting in a second party from the two or more other parties being a winning party; and initiating contact between the winning party and the first party.

In some embodiments, the method 400 may further include determining an insurance policy to cover a first item of the one or more items; and initiating an insurance policy acquisition procedure to secure the insurance policy for the first item.

In certain embodiments, the method 400 may further include determining, by executing the ML chatbot, an accountability score for an associated party of the first item; determining whether the accountability score satisfies an accountability threshold; and responsive to determining that the accountability score satisfies the accountability threshold, determining the insurance policy.

In various embodiments, the method 400 may further include generating the set of associated parties based upon one or more of: (i) a social media commonality value; (ii) a geographic commonality value indicating a similarity of geographic location among/between associated parties; (iii) a risk commonality value indicating a similarity of risk tolerance among/between associated parties; (iv) an experience commonality value indicating a similarity of successful rentals among/between associated parties; (v) an accountability commonality value indicating a similarity of accountability scores among/between associated parties, the accountability scores indicating a likelihood of items from the one or more items becoming damaged once exchanged; or (vi) a compatibility value indicating the overall compatibility among/between associated parties.

In some embodiments, the method 400 may further include sending a list of items from the one or more items to a first party from the plurality of parties; receiving a response signal from the first party indicating, for each item from the list of items, one or more of: (i) a listed item is not owned by the first party, (ii) a listed item is owned by the first party, (iii) a listed item is owned by the first party and is available for renting, (iv) a listed item is not needed by the first party, (v) a listed item is needed by the first party and the first party does not need the item immediately, or (vi) a listed item is needed by the first party and the first party needs the listed item immediately; and generating, by executing the ML chatbot, the set of associated parties based upon the response signal.

In certain embodiments, the method 400 may further include anonymizing contact between respective parties from the set of associated parties and/or anonymizing, by executing the ML chatbot, identifying information of each party of the plurality of parties.

In various embodiments, the method 400 may further include one or more of: (i) generating, by executing the ML chatbot, one or more exchange terms for each item of the one or more items; (ii) negotiating, via the ML chatbot, exchange terms between associated parties; or (iii) finalizing, via the ML chatbot, a contractual agreement between the associated parties with agreed exchange terms.

### Additional Considerations

As used herein, the term “indicia” means both singular and plural. For example, the phrase “property inspection indicia” may mean either of a single property inspection indicium (e.g., a single leaking pipe) or multiple property inspection indicia (e.g., multiple leaking pipes, or a single leaking pipe and a building code violation, etc.).

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

1. A short-term rental system for intelligent coordination between a plurality of parties, the short-term rental system comprising:
one or more processors; and
a tangible, non-transitory memory having executable instructions contained thereon that, when executed by the one or more processors, cause the one or more processors to:
aggregate party data from the plurality of parties,
determine, by executing a machine learning (ML) chatbot, one or more items associated with each party of the plurality of parties, wherein the ML chatbot is trained using a plurality of training party data from a plurality of training parties as input to output a plurality of training items associated with the plurality of training parties,
generate, by executing the ML chatbot, a set of associated parties that includes at least a pair of parties from the plurality of parties for each item of the one or more items, and
for each set of parties, initiate contact between parties.

2. The short-term rental system of claim 1, wherein the instructions, when executed, further cause the one or more processors to aggregate the party data by:
scraping data from one or more personal accounts associated with respective parties, including one or more of:
(i) email account(s),
(ii) social media account(s),
(iii) text messages,
(iv) voice messages,
(v) voice mails,
(vi) voice memos,
(vii) photos, or
(viii) electronic calendars.

3. The short-term rental system of claim 1, wherein the plurality of parties includes a first party and a plurality of other parties, and wherein the instructions, when executed, further cause the one or more processors to:
receive a list of one or more items from the first party;
aggregate party data from the plurality of other parties;
determine, by executing a ML chatbot, one or more items associated with each party of the plurality of parties;
generate, by executing the ML chatbot, a set of associated parties based upon the one or more items associated with each party of the plurality of other parties and the one or more items received from the first party, wherein the ML chatbot is trained using historical sets of associated parties and associated items; and
initiate contact with the first party and every associated party in the set.

4. The short-term rental system of claim 1, wherein the instructions, when executed, further cause the one or more processors to:
generate, by executing the ML chatbot, one or more exchange terms for each of the one or more items, wherein the one or more exchange terms includes one or more of (i) a length of time of a rental period, (ii) a compensation value, (iii) a security deposit value, (iv) an insurance policy requirement, (v) a cash payment requirement, or (vi) a delivery requirement.

5. The short-term rental system of claim 4, wherein the instructions, when executed, further cause the one or more processors to:
generate, by executing the ML chatbot, the set of associated parties based upon the one or more exchange terms associated with each party.

6. The short-term rental system of claim 4, wherein a first item from the one or more items is associated with a first party, and wherein the instructions, when executed, further cause the one or more processors to generate the one or more exchange terms by:
determining, by executing the ML chatbot, a demand value for the first item based upon one or more of (i) a first metric corresponding to parties of the plurality of parties associated with at least one item similar to the first item, or (ii) a second metric corresponding to items from the one or more items that are similar to the first item.

7. The short-term rental system of claim 1, wherein a first item is associated with a first party of the plurality of parties, and the instructions, when executed, further cause the one or more processors to:
determine, by executing the ML chatbot, two or more other parties of the plurality of parties that are associated with the first item;
perform an auction between the two or more other parties for the first item, the auction resulting in a second party from the two or more other parties being a winning party; and
initiate contact between the winning party and the first party.

8. The short-term rental system of claim 1, wherein the instructions, when executed, further cause the one or more processors to:
determine an insurance policy to cover a first item of the one or more items; and
initiate an insurance policy acquisition procedure to secure the insurance policy for the first item.

9. The short-term rental system of claim 8, wherein the instructions, when executed, further cause the one or more processors to determine the insurance policy by:
determining, by executing the ML chatbot, an accountability score for an associated party of the first item;
determining whether the accountability score satisfies an accountability threshold; and
responsive to determining that the accountability score satisfies the accountability threshold, determining the insurance policy.

10. The short-term rental system of claim 1, wherein the instructions, when executed, further cause the one or more processors to generate the set of associated parties based upon one or more of:
(i) a social media commonality value;
(ii) a geographic commonality value indicating a similarity of geographic location among/between associated parties;
(iii) a risk commonality value indicating a similarity of risk tolerance among/between associated parties;
(iv) an experience commonality value indicating a similarity of successful rentals among/between associated parties;
(v) an accountability commonality value indicating a similarity of accountability scores among/between associated parties, the accountability scores indicating a likelihood of items from the one or more items becoming damaged once exchanged; or
(vi) a compatibility value indicating the overall compatibility among/between associated parties.

11. The short-term rental system of claim 1, wherein the instructions, when executed, further cause the one or more processors to do one or more of:
(i) generate, by executing the ML chatbot, one or more exchange terms for each item of the one or more items;
(ii) negotiate, via the ML chatbot, exchange terms between associated parties; or
(iii) finalize, via the ML chatbot, a contractual agreement between the associated parties with agreed exchange terms.

12. The short-term rental system of claim 1, wherein the instructions, when executed, further cause the one or more processors to:
send a list of items from the one or more items to a first party from the plurality of parties;
receive a response signal from the first party indicating, for each item from the list of items, one or more of:
(i) a listed item is not owned by the first party,
(ii) a listed item is owned by the first party,
(iii) a listed item is owned by the first party and is available for renting,
(iv) a listed item is not needed by the first party,
(v) a listed item is needed by the first party and the first party does not need the item immediately, or
(vi) a listed item is needed by the first party and the first party needs the listed item immediately; and
generate, by executing the ML chatbot, the set of associated parties based upon the response signal.

13. The short-term rental system of claim 1, wherein the instructions, when executed, further cause the one or more processors to do one or more of:
(i) anonymize contact between respective parties from the set of associated parties; or
(ii) anonymize, by executing the ML chatbot, identifying information of each party of the plurality of parties.

14. A computer implemented method for intelligent coordination between a plurality of parties, the method comprising:
aggregating party data from the plurality of parties;
determining, by executing a machine learning (ML) chatbot, one or more items associated with each party of the plurality of parties, wherein the ML chatbot is trained using a plurality of training party data from a plurality of training parties as input to output a plurality of training items associated with the plurality of training parties;
generating, by executing the ML chatbot, a set of associated parties that includes at least a pair of parties from the plurality of parties for each item of the one or more items; and
for each set of parties, initiating contact between parties.

15. The computer implemented method of claim 14, wherein aggregating the party data further comprises:
scraping data from one or more personal accounts associated with respective parties, including one or more of:
(i) email account(s),
(ii) social media account(s),
(iii) text messages,
(iv) voice messages,
(v) voice mails,
(vi) voice memos,
(vii) photos, or
(viii) electronic calendars.

16. The computer implemented method of claim 14, wherein the plurality of parties includes a first party and a plurality of other parties, further comprising:
receiving a list of one or more items from the first party;
aggregating party data from the plurality of other parties;
determining, by executing a ML chatbot, one or more items associated with each party of the plurality of parties;
generating, by executing the ML chatbot, a set of associated parties based upon the one or more items associated with each party and the one or more items received from the first party, wherein the ML chatbot is trained using historical sets of associates parties and associated items; and
initiating contact with the first party and every associated party in the set.

17. A computer-readable storage medium comprising non-transitory computer readable instructions stored thereon for intelligent coordination between a plurality of parties, wherein the instructions when executed on one or more processors cause the one or more processors to:
aggregate party data from the plurality of parties;
determine, by executing a machine learning (ML) chatbot, one or more items associated with each party of the plurality of parties, wherein the ML chatbot is trained using a plurality of training party data from a plurality of training parties as input to output a plurality of training items associated with the plurality of training parties;
generate, by executing the ML chatbot, a set of associated parties that includes at least a pair of parties from the plurality of parties for each item of the one or more items; and
for each set of parties, initiate contact between parties.

18. The computer-readable storage medium of claim 17, wherein the instructions, when executed, further cause the one or more processors to aggregate the party data by:
scraping data from one or more personal accounts associated with respective parties, including one or more of:
(i) email account(s),
(ii) social media account(s),
(iii) text messages,
(iv) voice messages,
(v) voice mails,
(vi) voice memos,
(vii) photos, or
(viii) electronic calendars.

19. The computer-readable medium of claim 17, wherein the plurality of parties includes a first party and a plurality of other parties, and wherein the instructions, when executed, further cause the one or more processors to:
receive a list of one or more items from the first party;
aggregate party data from the plurality of other parties;
determine, by executing a ML chatbot, one or more items associated with each party of the plurality of parties;
generate, by executing the ML chatbot, a set of associated parties based upon the one or more items associated with each party and the one or more items received from the first party, wherein the ML chatbot is trained using historical sets of associates parties and associated items; and
initiate contact with the first party and every associated party in the set.

20. The computer-readable medium of claim 17, wherein the instructions, when executed, further cause the one or more processors to:
generate, by executing the ML chatbot, one or more exchange terms for each of the one or more items, wherein the one or more exchange terms includes one or more of (i) a length of time of a rental period, (ii) a compensation value, (iii) a security deposit value, (iv) an insurance policy requirement, (v) a cash payment requirement, or (vi) a delivery requirement.
